(19) United States
(12) Patent Application Publication
(10) Pub. No.: US 2014/0165767 A1
(43) Pub. Date: Jun. 19, 2014

(54) MANUAL SYNCHRONIZED GEAR SHIFT ASSIST

(71) Applicant: DEERE AND COMPANY, Moline, IL (US)

(72) Inventors: John J. Gallen, Waterloo, IA (US); Peter Wetrich, Waterloo, IA (US); Mark J. Tieszen, Hudson, IA (US); Mark A. Herman, Vinton, IA (US)

(73) Assignee: Deere and Company, Moline, IL (US)

(21) Appl. No.: 13/719,413

(22) Filed: Dec. 19, 2012

(51) Int. Cl. F16H 59/10

(52) U.S. Cl. CPC F16H 59/10
USPC 74/473.33

(57) ABSTRACT

The present disclosure provides a gear shift assembly for shifting a transmission between a plurality of ranges. The assembly includes a user input adapted to be moved to induce a shift between two of the plurality of ranges and a shaft coupled to the user input. A movement of the user input induces a first movement of the shaft. The gear shift assembly also includes a first range member movably coupled to the shaft, where the first range member moves concomitantly with the shaft. A second range member is coupled to the shaft. The second range member also moves concomitantly with the shaft. The assembly further includes a control valve disposed in fluid communication with the second range member. The control valve is operably controlled in response to movement of the user input to direct fluid to the second range member to induce a second movement of the shaft.

### FIELD OF THE DISCLOSURE

The present disclosure relates to a transmission of a machine, and in particular, to an integrated mechanism for synchronously shifting gears of the transmission.

### BACKGROUND OF THE DISCLOSURE

Many work machines are driven by a power-generating mechanism such as an engine or motor, and the power-generating mechanism provides power to a transmission for shifting the machine between a plurality of gears or ranges. The transmission can be an automatically controlled, semi-automatically controlled, or manually controlled. In a manually controlled transmission, for instance, a machine operator can control the shifting of the transmission via one or more controller inputs. A controller input may include a joystick, a shift lever, pedal, buttons, switches, etc.

A shift lever, for example, can be manually moved between each gear or range in an operator interface. For purposes of this disclosure, a gear or range are used interchangeable and each is intended to mean a selection made by the operator or transmission to shift between different gear ratios to achieve desired machine performance. An operator interface may identify each gear or range the transmission can shift into. For instance, a transmission may shift between park, neutral, a first range, a second range, etc. The operator interface may identify each gear or range accordingly, and the operator can move the lever or joystick to a desired gear or range barring any safety or preventative measures incorporated into the shifting of the transmission (e.g., not allowing the transmission to shift into park until machine ground speed reaches a threshold speed).

Depending on the operator interface and the type of shift being made, some shifts can take an extended period of time to complete. In a down-shift, for example, the machine may be travelling at a high ground speed. The operator, however, may desire to shift to a lower gear or range to operate at a lower ground speed, but in doing so the shift may take longer to complete than other shifts. Moreover, the machine operator may have to exert greater force to move the shift lever or joystick to the lower gear or range. The extended shift time and greater force required to move the shift lever can be undesirable, particularly to the machine operator.

Therefore, a need exists to provide a transmission that can achieve different shifts more quickly and with less effort from the machine operator.

### SUMMARY

In an exemplary embodiment of the present disclosure, a gear shift assembly is provided for shifting a transmission between a plurality of ranges. The transmission includes an outer housing and a plurality of shift rails disposed in the outer housing. The assembly includes a user input adapted to be moved to induce a shift between two of the plurality of ranges and a shaft coupled to the user input. A movement of the user input induces a first movement of the shaft. The gear shift assembly also includes a first range member movably coupled to the shaft, where the first range member moves concomitantly with the shaft and is configured to engage with the plurality of shift rails. A second range member is coupled to the shaft, where the second range member moves concomitantly with the shaft. The assembly further includes a control valve disposed in fluid communication with the second range member. The control valve is operably controlled in response to a movement of the user input to direct fluid to the second range member to induce a second movement of the shaft.

In one aspect of this embodiment, the cross shaft and second range member are disposed internal of the outer housing. In another aspect, the second range member comprises a rod and a piston, such that the rod is coupled at one end to the piston and at an opposite end to the shaft. Moreover, the piston is disposed in fluid communication with the control valve. In a different aspect, the second range member comprises a collar portion and a fork portion, the collar portion coupled to the shaft and the fork portion coupled to the rod. In yet another aspect, the gear shift assembly includes a pin coupled to the fork portion, where the rod includes a collar that is slidably coupled to the pin. In addition, a movement of the piston hydraulically induces an approximate simultaneous movement of the first and second range members. The gear shift assembly can also include at least one energizing device electrically coupled to the control valve.

In another embodiment, a machine includes a shift lever adapted to receive a user input and a transmission configured to shift the machine between a plurality of ranges. The transmission includes an outer housing and a shift rail assembly. A shaft is movably coupled to the shift lever, where the shaft is configured to move linearly or rotationally in response to a movement of the shift lever. Moreover, a first range member is coupled to the shaft such that the first range member moves concomitantly with the shaft to engage the shift rail assembly to induce a shift. In addition, a second range member is coupled to the shaft, where the second range member moves concomitantly with the shaft. The machine further includes a rod coupled to one end of the second range member, a piston coupled to the rod, and a valve disposed in fluid communication with the piston, where the valve is controlled to direct fluid to the piston to induce movement of the second range member in response to a movement of the shift lever.

In one aspect of this embodiment, the transmission includes a fluid supply and a defined fluid path between the fluid supply and piston. The defined fluid path includes a first path and a second path, the first path defined between the valve and a first side of the piston and the second path defined between the valve and a second side of the piston, where the first side is opposite the second side. Related thereto, in a first position the valve is disposed in the transmission to direct fluid in the first path to move the piston in a first direction, and in a second position the valve is disposed in the transmission to direct fluid in the second path to move the piston in a second direction. Here, movement by the piston in the first direction induces a clockwise rotational movement of the first and second range members, and movement by the piston in the second direction induces a counterclockwise rotational movement of the first and second range members.

In a different aspect, the second range member, rod, piston, and valve are disposed internally within the outer housing. Moreover, the second range member comprises a collar portion and a fork portion, the collar portion being coupled to the shaft and the fork portion defining a pair of openings through which a pin is disposed. In addition, the rod comprises a collar that is slidably coupled to the pin, such that a movement of the shaft induces a sliding movement of the rod along the pin. In a similar aspect, the valve can be electrically coupled to a solenoid and movement of the piston due to hydraulic pressure induces an approximate simultaneous movement of the first and second range members.

In a different embodiment, a method is provided for shifting a transmission in a machine between a plurality of ranges. The machine includes a shift lever and the transmission includes a shaft coupled to the shift lever, a first shift rail, a second shift rail, a synchronizer assembly coupled to the first and second shift rails, a first range member and a second range member coupled to the shaft, a rod coupled to one of the second range member, a piston coupled to the rod, and a control valve. The method includes moving the shift lever to shift the transmission to a desired range, moving the shaft in response to the movement of the shift lever, supplying fluid to the valve, controlling the valve to direct fluid to the piston, applying hydraulic pressure to one side of the piston, inducing a movement of the rod and second range member, engaging the first range member with either the first or second shift rail, and shifting the transmission to the desired range.

In one aspect of this embodiment, the method includes moving the first and second range members approximately simultaneously in the same direction. In another aspect, the method includes moving the first range member and second range member concomitantly with the shaft. In a different aspect, the method includes sliding the rod relative to the second range member in response to movement of the shaft.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side perspective view of a machine;

FIG. 2 is a side perspective view of a transmission and operator shift lever;

FIG. 3 is a perspective view of an integrated shift assembly for the transmission and shift lever of FIG. 2;

FIG. 4 is an enhanced perspective view of the integrated shift assembly of FIG. 3;

FIG. 5 is an exploded view of a shift assist assembly;

FIG. 6 is a partial bottom perspective view of a shift rail assembly and synchronizer assembly;

FIG. 7 is a cross-sectional view of the shift assist assembly of FIG. 5; and

FIG. 8 is a schematic view of a different embodiment of a transmission system including a shift assist assembly.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

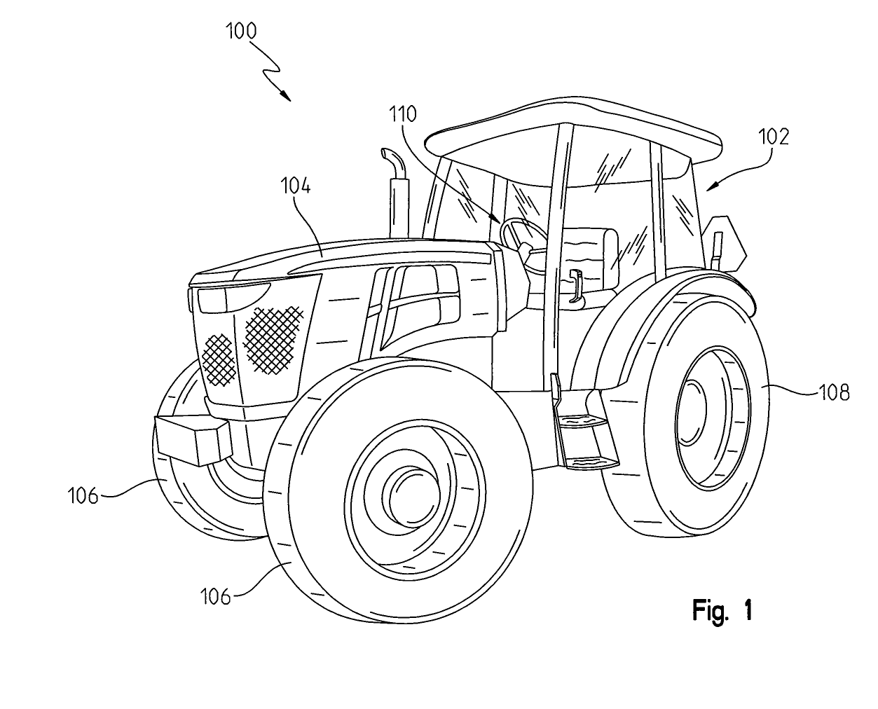

The present disclosure is not exclusively directed to any type of machine or tractor, but rather can extend to other powered vehicles as well. For exemplary and illustrative purposes, however, the present disclosure will focus on a utility tractor. In FIG. 1, for example, a machine 100, such as the 5M Utility Tractor manufactured and sold by Deere & Company, includes a cab 102 where an operator can control the operation of the machine 100. The machine 100 can include an outer frame 104 to which a front and rear axle (not shown) are connected. The front axle can have a pair of front ground engaging means 106 (e.g., wheels) mounted thereto and the rear axle can have a pair of rear ground engaging means 108 (e.g., wheels) mounted thereto. Operator controls 110, such as a steering wheel, shift lever, shift buttons, dashboard display, etc., can be disposed in the cab 102. One or more of these operator controls 110 can be operably coupled to a machine's transmission for controlling the operation of the machine 100.

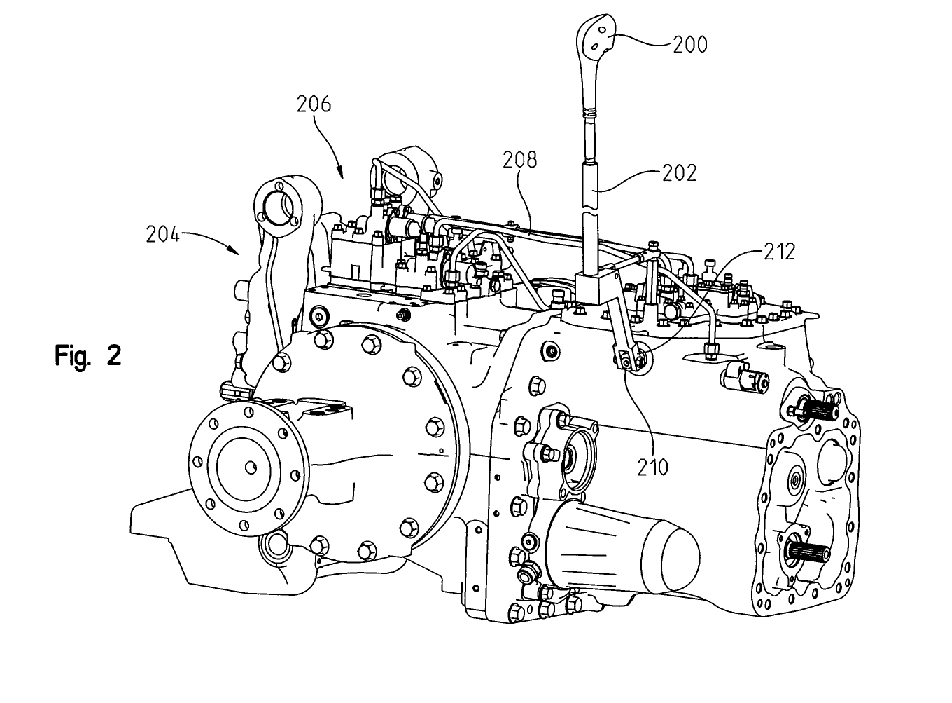

Referring to FIG. 2, for example, one such operator control 110 is a shift lever 200. The shift lever 200 can be disposed in the cab 102 so that a machine operator can manually control the shifting of a transmission 204. The transmission 204 can be disposed underneath the cab 102 and the shift lever 200 can be coupled to the transmission 204 via a mechanical linkage 202. The mechanical linkage 202 can be coupled to a cross shaft 210 as shown in FIG. 2. The cross shaft 210 can be coupled to the linkage 202 via a pin 212 or other fastener. In this manner, the shaft 210 can be rotationally and linearly actuated in response to a movement of the shift lever 200.

The transmission 204 can include a control manifold 206 integrally coupled with the transmission 204 for providing or communicating fluid to different portions of the transmission. As will be described, a fluid supply line 208 is fluidly coupled at one end to the control manifold 206. At an opposite end, the fluid supply line 208 is coupled to an internal flow path of the transmission 204. The internal flow path can be fluidly coupled to a shift assembly of the transmission 204 to achieve quicker shifts that require less manual force applied to the shift lever 200.

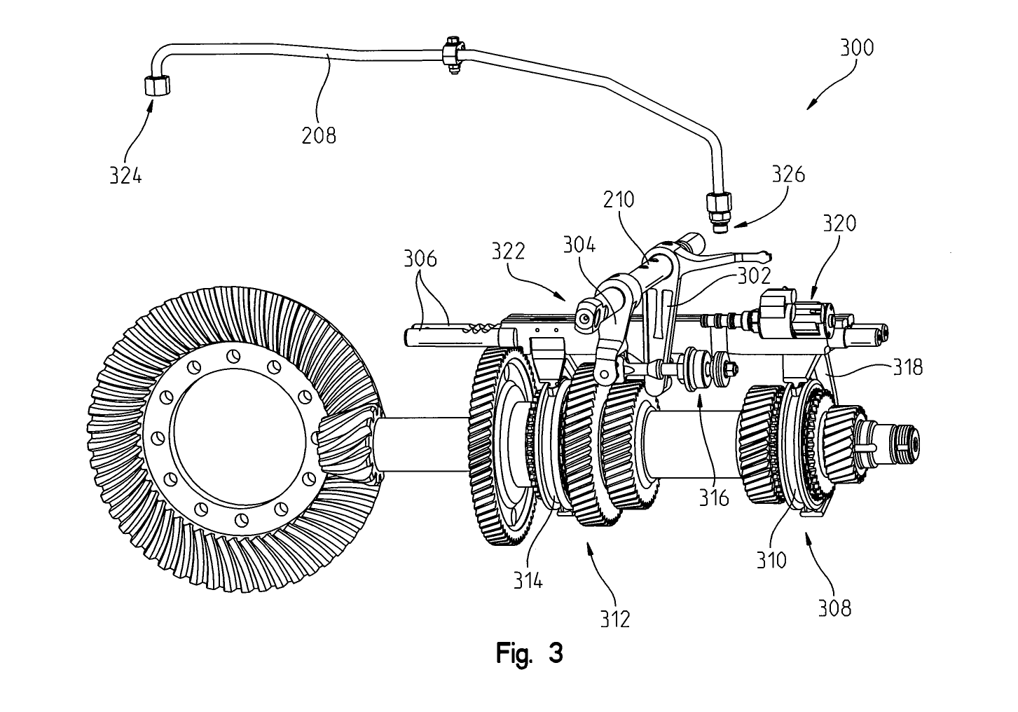

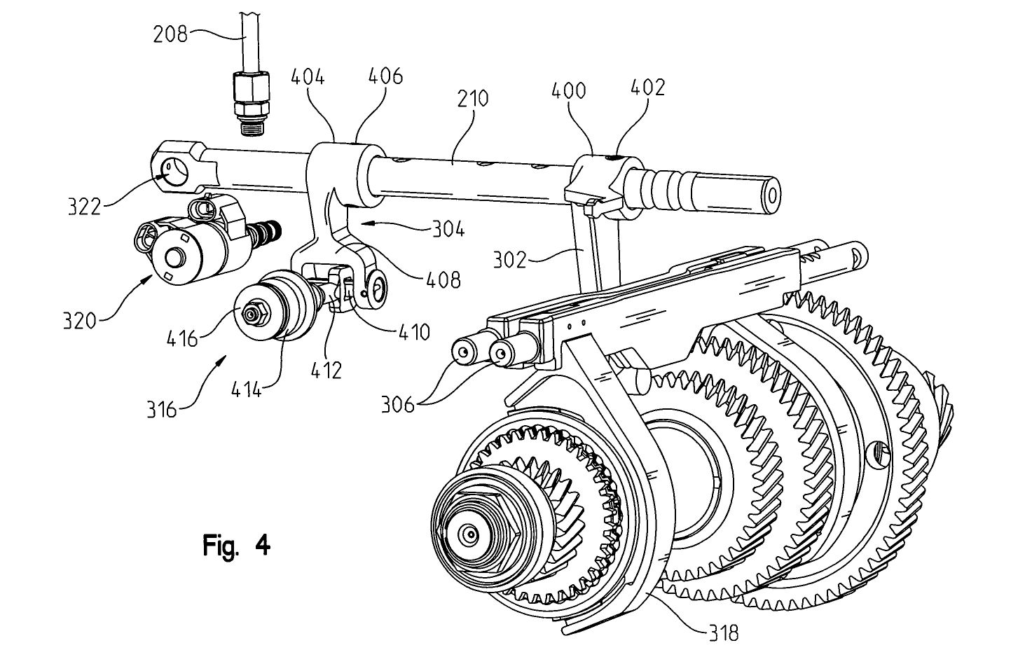

Referring to FIG. 3, an exemplary shift assembly 300 is shown. The shift assembly 300 includes the cross shaft 210. The cross shaft 210 can include a defined opening 322 at one end thereof to receive the pin 212 and mechanically couple the shaft 210 to the linkage 202. The shift assembly 300 further includes a range arm or member 302 that is coupled at one end to the cross shaft 210. As shown in FIG. 4, the range arm or member 302, or range member, includes a collar portion 400 at the one end that can be coupled to the cross shaft 210 via a pin 402. In this manner, as the cross shaft 210 moves either axially or rotationally due to a force applied to the shift lever 200, the range arm or member 302 moves in a concomitant relationship with the cross shaft 210.

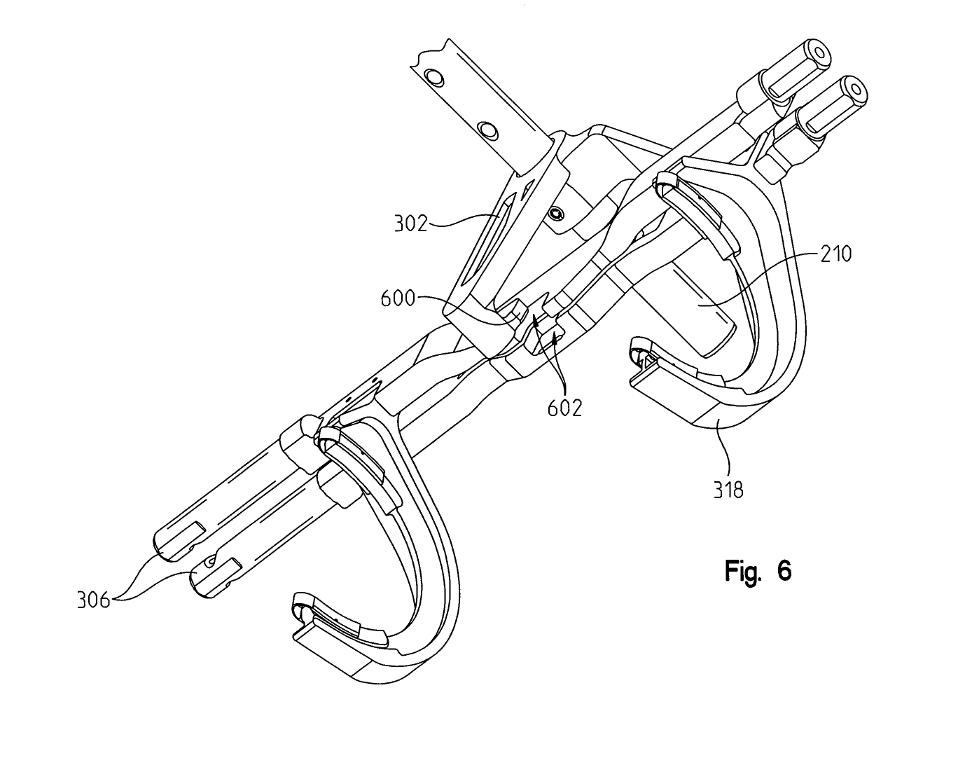

At an end opposite the collar portion 400, the range arm or member 302 can include a tab or rib 600 that extends therefrom. As shown in FIG. 6, the tab or rib 600 can extend in a direction towards the cross shaft 210. To initiate a shift between gears or ranges of the transmission 204, the shift assembly 300 includes a pair of shift rails 306. The number of shift rails 306 can depend on the number of gears or ranges into which the transmission 204 can shift. As shown in FIG. 6, each shift rail 306 can define a slot 602 near a bottom side thereof. During a manual shift, the cross shaft 210 can slide axially or rotationally so the range arm or member 302 engages one of the shift rails 306. In particular, the tab 600 of the range arm or member 302 has a defined shape to engage within the slot 602 of either shift rail 306.

As shown in FIGS. 3 and 6, the shift assembly 300 can also include a synchronizer assembly. The synchronizer assembly can include a first synchronizer 308 and a second synchronizer 312. Moreover, the first synchronizer 308 includes a defined channel or collar 310 and the second synchronizer 312 includes a defined channel or collar 314. To engage either synchronizer, the shift rails 306 include a fork 318 as shown in FIGS. 3 and 6. The fork 318 can have a rib structure that can engage within the defined channel or collar of either synchronizer. The engagement and interaction between the shift rails 306 and synchronizer assembly can be achieved according to other known means in the art, and the illustrated structure in FIGS. 3 and 6 only provides one example of this interaction. The shifting between different gears or ranges can depend on which shift rail 306 is engaged by the range arm or member 302. The shift assembly 300 can include conventional clutches, gearsets, shafts, and the like for shifting the transmission 204.

As previously described, many conventional manual shift or semi-manual shift transmissions can require high operator force to move the shift lever between gears or ranges. In addition, many of these shifts can take extended periods of time to complete due to the conventional arrangement of the shift assembly. To overcome some of the undesirable aspects of conventional systems, the shift assembly 300 in FIG. 3 includes a shift assist assembly 316. The shift assist assembly 316 can provide an additional force or exertion to the range arm or member 302 to engage the shift rails 306 more quickly and with less operator force. In other words, the shift assist assembly 316 provides an approximately simultaneous force to the cross shaft 210 to improve the shift quality of the transmission. The shift assist assembly 316 can include mechanical, hydraulic, pneumatic, and electrical components to assist with the shifting of the transmission.

In FIGS. 3 and 4, for example, the shift assist assembly 316 can include a second range arm or range member 304. The second range arm or member 304 can be directly coupled to the cross shaft 210 via a pin 406 or other means. The second range arm or member 304 can include a collar portion 404 similar to the collar portion 400 of the first range arm or member 302. The collar portion 404 is disposed at one end of the second range arm or member 304 and is coupled to the shaft 210. More particularly, the collar portion 404 of the second range arm or member 304 defines an opening 508 through which the cross shaft 210 is disposed. A second pin 510 (in addition to pin 406) can further couple the second range arm or member 304 to the cross shaft 210.

As such, the second range arm or member 304 can move axially or rotationally in a concomitant relationship with the cross shaft 210. More specifically, the first range arm or member 302 and second range arm or member 304 can move axially or rotationally in an approximately simultaneous relationship with one another. Thus, a movement of the second range arm or member 304 causes a similar movement of the first range arm or member 302 both in terms of type of movement (e.g., linear, rotational, etc.) and direction (e.g., axial, clockwise, etc.).

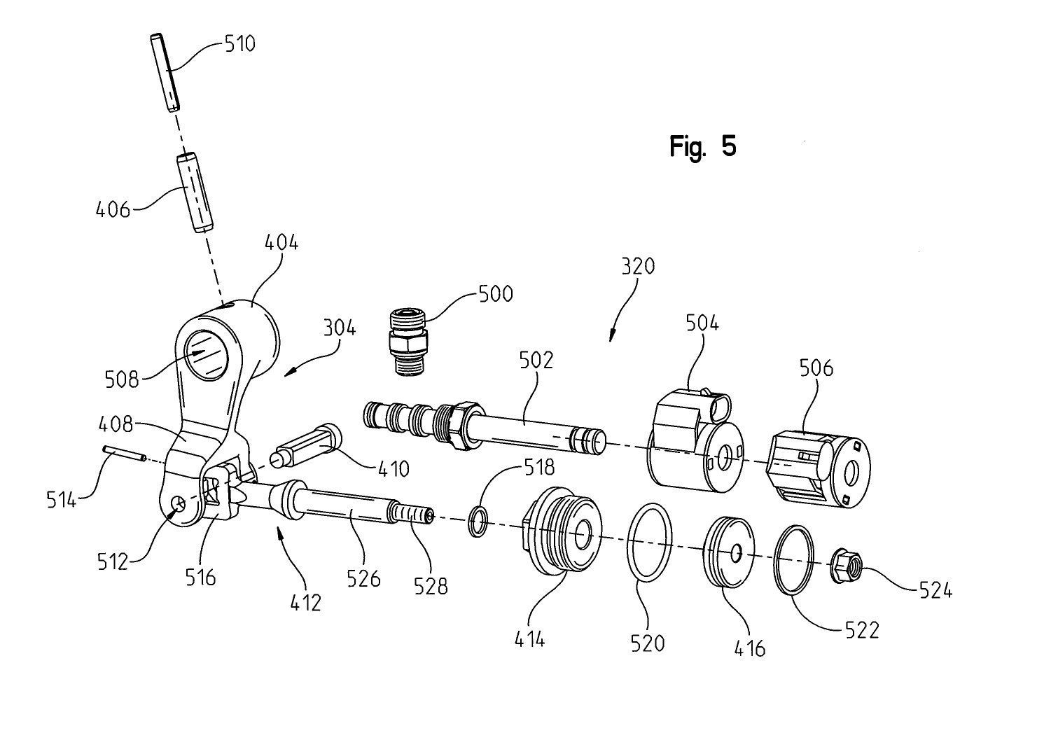

Besides movement of the second range arm or member 304 due to a force exerted on the shift lever 200 by a machine operator, the second range arm or member 304 can also be moved by a control valve 320. The control valve 320 can be operably coupled to one or more solenoids to induce movement of the valve 320. The valve 320 can also be disposed in a fluid cavity of the transmission to move in a substantially axial direction to control the direction of fluid flowing through an internal flow path in the transmission. Moreover, the valve 320 can be disposed in fluid communication with a fluid supply, such as an internal pump. As previously described with respect to FIG. 2, the transmission 204 can include a control manifold 206 that serves as a fluid supply to different portions of the transmission 204. The fluid supply line 208 can be coupled at one end to the control manifold 206 and at an opposite end to the flow cavity in which the control valve 320 is disposed (see FIG. 3). The fluid supply line 208 can include an inlet 324 for receiving fluid and an outlet 326 disposed near the valve 320 in the transmission 204. In FIG. 5, an outlet fitting 500 can be coupled to the fluid supply line 208 and integrally disposed within the fluid path of the transmission 204 to deliver the fluid to the control valve 320. As also shown in FIG. 2, the fluid supply line 208 can be external relative to the transmission 204. In other embodiments, however, its possible for the fluid supply line 208 to be integrated within the transmission 204. In addition, the fluid supplied to the control valve 320, and in particular to the fluid cavity, can also be supplied to control clutches, valves, solenoids, and other elements of the transmission 204.

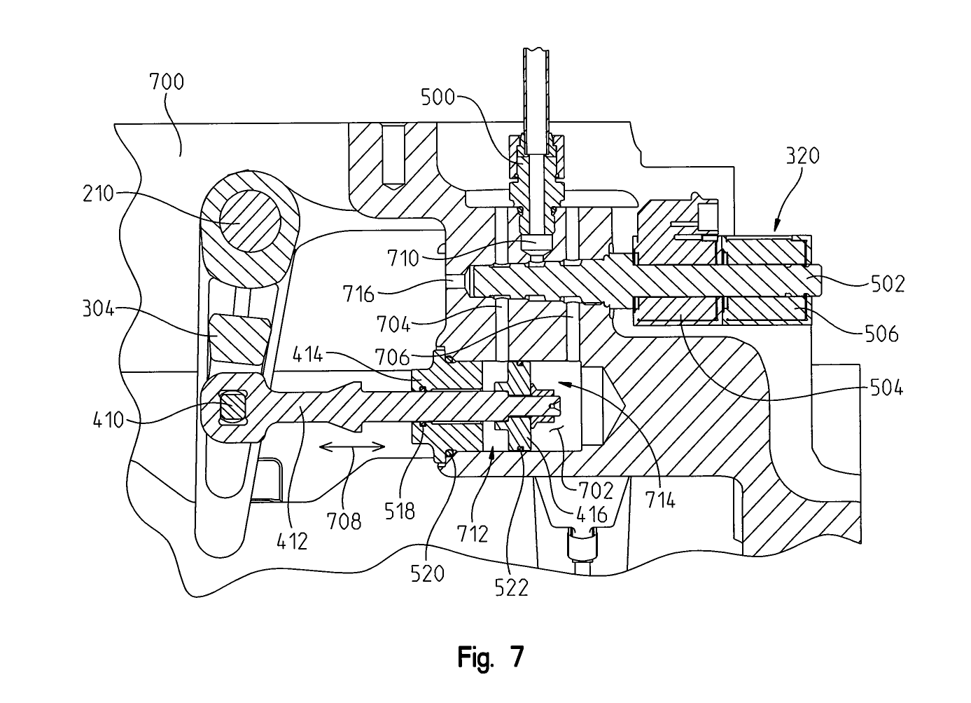

The control valve 320 can be controlled by a variety of means. For example, a solenoid or other electrically-actuating device can control movement of the valve 320. Alternatively, the valve 320 can be hydraulically controlled by the fluid disposed in the transmission. Other means for controlling the movement of a valve may be incorporated into the design as well. In addition, the valve 320 can be a four-way, three-position valve 320 as will be described with reference to FIG. 7. In FIG. 5, the control valve 320 is shown as having a valve portion 502 that controls how fluid is directed in the transmission 204. The valve portion 502 can be operably controlled by a first solenoid 504 and a second solenoid 506. The first solenoid 504 and second solenoid 506 can include defined openings through which part of the valve portion 502 can be disposed. Besides the embodiment shown and described herein, the valve 320 can be operably controlled between a plurality of positions depending on the transmission design and need for shifting the transmission.

The positioning of the valve 320 can further control movement of the second range arm or member 304. To achieve this interaction between the control valve 320 and second range arm or member 304, the range assist assembly 316 includes a double-acting cylinder assembly (i.e., piston rod assembly) disposed in the transmission 204. Referring to FIGS. 4 and 5, the double-acting cylinder assembly can include a rod 412 that is coupled at one end to the second range arm or member 304. In addition, a piston 416 is coupled near an opposite end of the rod 412. The piston 416 can have an outer circumference about which a piston seal 522 is seated.

The rod 412 can have three different sections or portions. For instance, the rod 412 can include a collar portion 516 for interacting with the second range arm or member 304. In addition, the rod 412 can include a cap portion 526 and a piston portion 528. The piston 416 can be disposed about the piston portion 528 of the rod 412, whereas a cap 414 can be disposed about the cap portion 526 of the rod 412. The cap 414 can include a seal 520 disposed about its outer surface and can fit within a defined area of the transmission 204. Another seal or o-ring 518 can be coupled to the cap portion 526 of the rod 412 and a nut 524 or other fastener can secure the piston 416 to the rod 412.

The collar portion 516 of the rod 412 can be slidably engaged with a transverse pin 410 that is coupled to the second range arm or member 304. As shown in FIG. 5, the second range arm or member 304 can include a fork portion 408 disposed at an end opposite the collar 404. The fork portion 408 can include two elements with defined openings 512 aligned with one another. The transverse pin 410 can be disposed in the defined openings 512 and another pin 514 can be disposed in other openings in the fork portion 408 to couple the transverse pin 410 to the second range arm or member 304. In this aspect, the transverse pin 410 moves along with the fork portion 408 of the second range arm or member 304 relative to the collar portion 516 of the rod 412. In this manner, the collar portion 516 defines an opening through which the transverse pin 410 slides relative to the collar portion 516.

Referring to FIG. 7, a portion of the transmission housing 700 is shown. The housing 700 defines a cylinder cavity 702 that has a defined interior thereby forming part of the double-acting cylinder assembly. Moreover, the cavity 702 is defined at one end by the cap 414 and is fluidly coupled to the control valve 320 via a first flow channel 704 and a second flow channel 706. As shown, the piston 416 can move axially within the cavity 702, and in doing so, it divides the cavity 702 into a first fill cavity 712 and a second fill cavity 714. The piston seal 522 can fluidly isolate the first fill cavity 712 from the second fill cavity 714 so fluid cannot leak therebetween. In addition, fluid can be introduced to the shift assist assembly 316, and in particular to the control valve 320, through an inlet cavity 710 that is disposed on a side of the valve 320 opposite the first and second flow channels. Therefore, controlled movement of the valve 320 can fluidly couple the inlet cavity 710 with either the first flow channel 704 or second flow channel 706. As further shown in FIG. 7, the inlet cavity 710 is disposed in fluid communication with the outlet fitting 500 of the fluid supply line 208, and therefore the fluid supply is fluidly coupled to either side of the piston 416 based on the position of the control valve 320.

In the embodiment of FIG. 7, the shift assist assembly 316 and cylinder cavity 702 are integrated into the transmission housing 700 and can assist the shifting of the transmission by providing a supplemental or secondary force to the shift assembly 300, and in particular, to the synchronizer assembly to induce a shift between gears or ranges. During operation, the machine operator can exert an input to the shift lever 200 to complete a desired shift. In response to the operator input, the cross shaft 210 moves either linearly or rotationally. Due to the movement of the cross shaft 210, the first and second range arms or members move concomitantly. To assist or reduce the effort and timing to complete this shift, an electrical command can be transferred to the control valve 320 to controllably move the valve 320 in an axial direction indicated by arrow 708.

As the valve 320 is controlled to one of a plurality of positions, fluid from the fluid supply line 208 can fill the inlet cavity 710 of the flow path defined in the transmission housing 700. In a first position, the valve 320 can release fluid from the inlet cavity 710 into the first flow channel 704. The fluid can then fill the first fill cavity 712 of the cylinder cavity 702. As fluid fills the cavity 712, hydraulic pressure builds and exerts a force against the piston 416 and urges the piston 416 to move in an axial direction indicated by arrow 708. In this manner, the rod 412 exerts a related force against the transverse pin 410 and moves in the same direction as the piston 416.

As the rod 412 moves due to the hydraulic force applied against the piston 416, the transverse pin 410 is forced to move thereby causing the second range arm or member 304 to move in a counterclockwise direction relative to an axis (not shown) defined by the cross shaft 210. This hydraulic force applied to the piston 416 can assist with moving the second range arm or member 304 in a direction similar to that of the first range arm or member 302, thus reducing the overall force required to make the shift. Moreover, this supplemental or secondary force produced by the hydraulic pressure in the cylinder cavity 702 can further increase the force applied to the shift rail 306 corresponding to the desired shift. This greater force can be passed along to the synchronizer assembly to reduce the amount of time required to complete the desired shift.

Since the valve 320 can be controlled between several positions, fluid can be released from the inlet cavity 710 into the second flow channel 706 to assist with a different desired shift. Here, fluid passing through the second flow channel 706 can fill the second fill cavity 714 of the cylinder cavity 702. In doing so, hydraulic pressure builds in the second fill cavity 714 thereby applying a hydraulic force to the opposite side of the piston 416 and moving the piston 416 and rod 412 linearly along an axial direction 708. As such, the second range arm or member 304 is forced to move in a clockwise direction relative to an axis defined by the cross shaft 210. The second range arm or member 304 therefore can reduce the effort or force required to move the first range arm or member 302 in a similar, clockwise direction to engage the shift rail 306 corresponding to the desired shift.

In a standard H-pattern operator interface in the cab of the machine, an operator can shift the transmission between a plurality of gears or ranges and the shift assist assembly 316 can reduce the effort required to do so and improve shift quality. For instance, an H-pattern interface may include a position A, a position B, a position C, and a position D each corresponding to a first range, a second range, a third range, and a fourth range, respectively. A first shift rail may correspond to the first and second ranges (i.e., A-B shift rail) and a second shift rail may correspond to the third and fourth ranges (i.e., C-D shift rail). Thus, an operator command to move between positions B and C may induce the first range arm or member 302 to disengage the A-B shift rail and engage the C-D shift rail. In any event, the force exerted on the shift lever 200 can be assisted or reduced by a similar command to the control valve 320 to direct fluid to the appropriate fill cavity and hydraulically apply the piston in a direction corresponding to the desired shift.

As previously described, the control valve 320 can be operably controlled between a plurality of positions depending on a desired shift. The control valve 320 can have a neutral position where the valve 320 does not prevent fluid from flowing from the inlet cavity 710 to either the first flow channel 704 or second flow channel 706. As such, the piston 416 is not urged in either direction and fluid can flow into and out of the cylinder cavity 702. In a three-way valve embodiment, the control valve 320 can move between a first position where only the inlet cavity 710 and first flow channel 704 are fluidly coupled, a second position where only the inlet cavity 710 and second flow channel 706 are fluidly coupled, and a third or neutral position where the inlet cavity 710 is fluidly blocked to both the first flow channel 704 and second flow channel 706. In this neutral position, a sump passage or channel 716 can be fluidly coupled to either or both of the first flow channel 704 and second flow channel 706. The sump passage 716 is fluidly coupled to a transmission sump.

Communication between the shift lever 200 and control valve 320 can be achieved in a variety of manners. For instance, the shift lever 200 may include a knob or other structure with integrated sensors that detect the amount of force exerted to the shift lever 200 and the direction by which the shift lever 200 is moved. The integrated sensors can be in electrical communication with a controller (not shown) or the solenoids 504, 506 to electrically control the valve 320. Alternatively, there can be sensors disposed in the transmission that detect movement of the shift lever 200, mechanical linkage 202, the cross shaft 210 or first range arm or member 302 and relay a command to a controller or solenoid for electrically controlling the valve 320. Other systems or means can be provided to detect movement, force, or position of the shift lever 200 or any of the components of the shift assembly 300 to operably control the shift assist assembly 316, and in particular the control valve 320.

In the event of an electrical or hydraulic failure in the transmission, the shift assembly 300 can still be operably controlled by the machine operator through mechanical input to the shift lever 200 or other user controls. In other words, in at least one aspect of this disclosure, the integration of the integrated shift assist assembly 316 in the transmission does not prevent or limit the manual control of the transmission. Moreover, while the shift assist assembly 316 has been described as a mechanism for assisting with the shifting of the transmission, it may also be used to limit or prevent a machine operator from attempting to shift the transmission into an undesirable or unsafe range due to vehicle circumstances and performance (e.g., trying to manually shift the transmission into a certain range at a machine speed that may cause damage to the transmission). In this manner, the hydraulic force exerted against the piston may counteract or oppose a force exerted by the machine operator on the shift lever. While this is not intended to be a primary purpose or functionality of the shift assist assembly, it is to be understood that the present disclosure can be used in additional ways besides those described herein.

The cross shaft 210 may also be controlled or moved by a variety of different mechanisms. For instance, rotational movement of the cross shaft 210 may be achieved by the internally integrated double-acting cylinder rod as previously described. Alternatively, an external, double-acting cylinder rod can also be used to control the rotational movement of the cross shaft 210. In addition, a linear-energizing device may be used to exert a linear force to the cross-shaft 210 or piston 416 to achieve desired shifting. The linear-energizing device may be through a hydraulic means, a pneumatic means, an electrically-energized solenoid, or a stepper motor for inducing a push-pull behavior. Rotational-energizing devices may include a hydraulic motor, a pneumatic motor, or an electric motor. In other words, there are alternative means and devices to achieve desired movement of the different components of the shift assembly 300 and shift assist assembly 316.

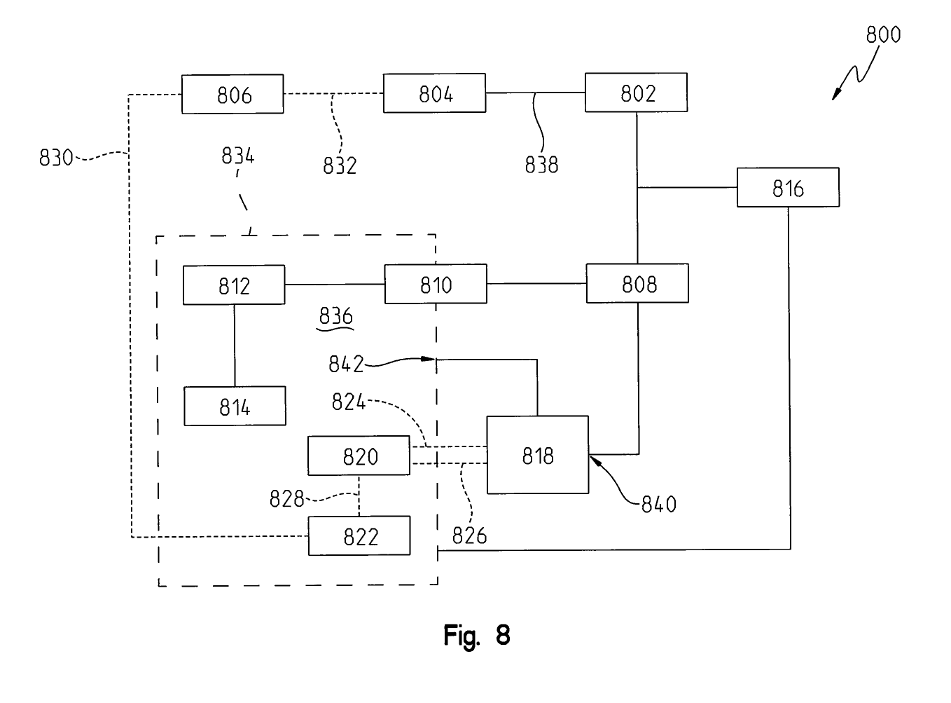

Referring to FIG. 8, a different embodiment of a transmission system 800 having a shift assist assembly is illustrated. The system 800 can include a shift lever 802, joystick, or other user controls for controlling the shifting of the transmission. The shift lever 802 can be electrically or mechanically coupled to a position sensor 804, which detects a position or range in which the transmission is shifted to. In turn, the position sensor 804 can be in electrical communication with a controller or switch 806 via communication link 832. In FIG. 7, connections, fluid paths or links are illustrated differently to distinguish the manner in which two or more elements are coupled. For instance, communication link 832 is shown as a broken or dashed line. As will be discussed, connection lines 824 and 826 are broken or dashed lines but represent fluid paths. However, the connection 838 between the shift lever 802 and position sensor 804 is shown as a solid line to represent a mechanical or partially mechanical connection. It should be understood that the connections, fluid paths, or communication links in FIG. 8 are only provided as one of many examples, and one skilled in the art may design these connections differently where a mechanical connection could be formed as an electrical connection, and vice versa.

The transmission system 800 further includes a transmission that is defined by an outer housing 834 and includes an interior 836. The transmission can include clutches, gears, shafts, and the like. The transmission can be mounted to an engine, motor or other power-generating device. In FIG. 8, the outer housing 834 of the transmission is shown with bold, broken lines such that features inside the housing 834 are disposed within the broken lines and features outside the housing 834 are disposed outside of the broken lines.

The shift lever 802 can be coupled to a cross shaft member 808 that is disposed outside the transmission outer housing 834. This cross shaft member 808 can move axially or rotationally when the shift lever 802 is actuated by a machine operator. A mechanical linkage similar to the one shown in FIG. 2 can be coupled between the shift lever 802 and cross shaft member 808. Moreover, a guide motion link 816 can be movably coupled at one end to the linkage between the shift lever 802 and cross shaft member 808. At an opposite end, the link 816 can be fixedly coupled to the outer housing 834 of the transmission.

The cross shaft member 808 can be coupled to a cross shaft 810 that is movably disposed about a cross shaft axis (not shown). The cross shaft 810 can be a substantially cylindrical shaft that is coupled at one end to the cross shaft member 808 and at an opposite end to a range member 812. As shown in FIG. 8, the cross shaft 810 can be disposed partially outside the transmission outer housing 834 and partially in the interior 836 of the transmission. The end of the cross shaft 810 that couples to the range member 812 can be disposed in the interior 836 of the transmission, whereas the end that couples to the cross shaft member 808 can be disposed outside the outer housing 834.

The cross shaft 810 can move axially along the cross shaft axis in response to a user input force applied to the shift lever 802. In addition, the cross shaft 810 can rotate either clockwise or counterclockwise about the cross shaft axis in response to movement of the shift lever 802. A movement of the cross shaft 810 can induce a movement by the range member 812. The range member 812 can be operably similar to the first range member 302 of FIG. 3. Specifically, the range member 812 can interact and engage with one or more shift rails 814 to induce a shift of the transmission. Thus, as a machine operator moves the shift lever 802 between shift positions (i.e., from one range to a different range), a corresponding movement is induced in the cross shaft member 808, cross shaft 810, and range member 812 to interact with the one or more shift rails 814 to complete a desired shift.

The embodiment of FIG. 8 can also include a range assist assembly to reduce the force required to complete a desired shift and to improve the shift timing of the shift. The range assist assembly can include a range assist member 818, a control valve 820, and one or more energizing devices 822. In one aspect, the one or more energizing devices can be a solenoid that is disposed in electrical communication with the controller 806 or position sensor 804. The electrical communication can be defined along a communication link 830 between the one or more energizing devices 822 and the controller 806. Moreover, the one or more energizing devices 822 can be electrically coupled to the control valve 828 via communication or connection link 828. The one or more energizing devices 822 can electrically control movement of the control valve 820 such that the control valve 820 can move between a plurality of positions similar to the control valve 320 of FIG. 3.

The range assist member 818 can include one or more components. For instance, the range assist member 818 can include a double-acting cylinder similar to the one described with reference to FIGS. 3-5 and 7. The range assist member 818 can also include a range member similar to the second range member 304 shown in FIG. 3. The structure and function of the range assist member 818 can take many different forms depending on the application.

In one, non-limiting example, the range assist member 818 can take the form of a double-acting cylinder. A first end 840 of the cylinder can be movably coupled to the cross shaft member 808 as shown in FIG. 8. An opposite end 842 of the double-acting cylinder can be coupled to the outer housing 834 of the transmission. The first end 840 of the cylinder can be part of a rod (not shown) that moves within an outer, cylindrical housing of the range assist member 818. Similar to the embodiment of FIG. 8, a piston (not shown) can be coupled to the rod (not shown) such that the piston and rod move concomitantly within the cylindrical housing of the range assist member 818. Similar to the embodiment of FIG. 7, the piston can be in fluid communication with the control valve 820 such that a first fill cavity (not shown) is disposed on one side of the piston (not shown) and a second fill cavity (not shown) is disposed on an opposite side of the piston (not shown). The first fill cavity (not shown) can be disposed in fluid communication with a first flow channel 824 and the second fill cavity (not shown) can be disposed in fluid communication with a second flow channel 826.

Therefore, the control valve 820 can control which fill cavity is filled with fluid and thereby hydraulically applies the piston to move axially within the cylindrical housing. Based on the direction the piston moves, the rod moves in the same direction. As the rod moves, the range assist member 818 moves in a concomitant relationship with the cross shaft member 808 and cross shaft 810 to assist by applying an ancillary force to the cross shaft 810 for reducing the overall force required to complete the desired shift. Moreover, this additional force can reduce the time it takes to complete the desired force. In this manner, the range assist member 818 can operate in a similar manner as the range assist assembly 316 of FIG. 3.

The control valve 820 can be operably moved by the one or more energizing devices 822 due to a signal sent from either the controller 806 or position sensor 804. As the machine operator moves the shift lever 802 to a different position to induce a desired shift, the position sensor 804 can detect the movement and position over link 838 to which the shift lever 802 is moved. This new position can be communicated by the position sensor 804 to the controller 806 over communication link 832. Likewise, the controller 806 can receive this detected new position and transmit an electrical signal over communication link 830 to the one or more energizing devices 822. This signal can actuate or energize one of the devices 822 to cause a corresponding movement of the control valve 820 to fill one of the first and second fluid paths. In turn, the range assist member 818 is operably controlled in this manner and provides a supplemental force to the transmission shift assembly.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A gear shift assembly for shifting a transmission between a plurality of ranges, the transmission including an outer housing and a plurality of shift rails disposed in the outer housing, comprising:
a user input adapted to be moved to induce a shift between two of the plurality of ranges;
a shaft coupled to the user input, where movement of the user input induces a first movement of the shaft;
a first range member movably coupled to the shaft, where the first range member moves concomitantly with the shaft and is configured to engage with the plurality of shift rails;
a second range member coupled to the shaft, where the second range member moves concomitantly with the shaft;
a control valve disposed in fluid communication with the second range member, wherein the control valve is operably controlled in response to a movement of the user input to direct fluid to the second range member to induce a second movement of the shaft.

2. The gear shift assembly of claim 1, wherein the cross shaft and second range member are disposed internal of the outer housing.

3. The gear shift assembly of claim 1, wherein:
the second range member comprises a rod and a piston, the rod being coupled at one end to the piston and at an opposite end to the shaft; and
the piston being disposed in fluid communication with the control valve.

4. The gear shift assembly of claim 3, wherein the second range member comprises a collar portion and a fork portion, the collar portion coupled to the shaft and the fork portion coupled to the rod.

5. The gear shift assembly of claim 4, further comprising a pin coupled to the fork portion, where the rod includes a collar that is slidably coupled to the pin.

6. The gear shift assembly of claim 3, wherein a movement of the piston hydraulically induces an approximate simultaneous movement of the first and second range members.

7. The gear shift assembly of claim 1, further comprising at least one energizing device electrically coupled to the control valve.

8. A machine, comprising:
a shift lever adapted to receive a user input;
a transmission configured to shift the machine between a plurality of ranges, the transmission including an outer housing and at least one flow path defined therein;
a shaft movably coupled to the shift lever, where the shaft is configured to move linearly or rotationally in response to a movement of the shift lever;
a first range member coupled to the shaft, the first range member moving concomitantly with the shaft;
a second range member coupled to the shaft, where the second range member moves concomitantly with the shaft;
a rod coupled to one end of the second range member;
a piston coupled to the rod; and
a valve disposed in fluid communication with the piston and at least one flow path, where the valve is controlled to direct fluid to the piston to induce movement of the second range member in response to a movement of the shift lever.

9. The machine of claim 8, wherein the transmission includes a fluid supply disposed in fluid communication with the valve and piston.

10. The machine of claim 9, wherein the at least one flow path includes a first channel and a second channel, the first channel defined between the valve and a first side of the piston and the second channel defined between the valve and a second side of the piston, where the first side is opposite the second side.

11. The machine of claim 10, wherein:
in a first position, the valve is disposed in the at least one flow path to direct fluid in the first channel to move the piston in a first direction; and
in a second position, the valve is disposed in the at least one flow path to direct fluid in the second channel to move the piston in a second direction, the first direction being substantially opposite the second direction;
wherein, movement by the piston in the first direction induces a clockwise rotational movement of the first and second range members, and movement by the piston in the second direction induces a counterclockwise rotational movement of the first and second range members.

12. The machine of claim 8, wherein the second range member, rod, piston, and valve are disposed internally within the outer housing.

13. The machine of claim 8, wherein the second range member comprises a collar portion and a fork portion, the collar portion being coupled to the shaft and the fork portion defining a pair of openings through which a pin is disposed.

14. The machine of claim 13, wherein the rod comprises a collar that is slidably coupled to the pin, such that a movement of the shaft induces a sliding movement of the rod along the pin.

15. The machine of claim 8, wherein the valve is electrically coupled to an energizing device.

16. The machine of claim 8, wherein a movement of the piston due to hydraulic pressure induces an approximate simultaneous movement of the first and second range members.

17. A method of shifting a transmission in a machine to a desired range, the machine including a shift lever and the transmission including a shaft coupled to the shift lever, a plurality of shift rails, a synchronizer assembly coupled to the plurality of shift rails, a first range member and a second range member coupled to the shaft, a rod movably coupled to the second range member, a piston coupled to the rod, and a control valve, the method comprising:
moving the shaft in response to a movement of the shift lever;
supplying fluid to the control valve;
controlling the control valve to direct fluid to the piston;
applying hydraulic pressure to one side of the piston;
inducing a movement of the rod and second range member in response to a movement of the piston;
engaging the first range member with one of the plurality of shift rails; and
shifting the transmission to the desired range.

18. The method of claim 17, further comprising moving the first and second range members approximately simultaneously in the same direction.

19. The method of claim 17, further comprising moving the first range member and second range member concomitantly with the shaft.

20. The method of claim 17, further comprising:
moving the rod and piston in a substantially linear direction; and
moving the second range member in either a substantially linear or rotational direction, wherein a linear movement by the rod and piston is approximately perpendicular to a linear movement of the second range member.
